(19) United States
(12) Patent Application Publication
(10) Pub. No.: US 2026/0211682 A1
(43) Pub. Date: Jul. 23, 2026

(54) VALUE PREDICTION

(71) Applicant: Arm Limited, Cambridge (GB)

(72) Inventor: Robert Douglas CLANCY, Apex, NC (US)

(21) Appl. No.: 19/034,741

(22) Filed: Jan. 23, 2025

(51) Int. Cl. G06F 9/38; G06F 9/30

(52) U.S. Cl. CPC G06F 9/3832; G06F 9/30047; G06F 9/3844

(57) ABSTRACT

An apparatus comprises value prediction storage storing value prediction entries, each value prediction entry providing a data value prediction associated with a corresponding instruction. A value prediction blocklist identifies one or more blocked instructions, and value prediction allocation circuitry is configured to control whether to allocate a given value prediction entry associated with a given instruction to the value prediction storage in dependence on whether the given instruction is identified as a blocked instruction by the value prediction blocklist. Blocklist allocation circuitry determines whether to add a target instruction to the value prediction blocklist in dependence on an allocation count indicating a number of times a value prediction entry associated with the target instruction has been allocated to the value prediction storage.

### BACKGROUND

### Technical Field

The present technique relates to the field of data processing.

### Technical Background

A processing apparatus may have value prediction circuitry for generating a data value prediction indicating a predicted result data value for a given instruction before the actual result data value of the given instruction is available. This can help other instructions dependent on the predicted instruction execute earlier based on the predicted result data value, which can improve performance if the data value prediction is correct. For example, a load instruction which retrieves a data value from a storage location in memory may be “in flight” for many processing cycles. Another instruction which follows the load instruction and makes use of that data value as a source value will therefore be held up until the load operation completes. Value prediction enables the data processing apparatus to progress the execution of such dependent instructions, working on the assumption that a predicted value will be correct. The penalty of correcting occasional errors in the predictions (by re-running instruction execution from the point at which the incorrect predicted value was used) can be outweighed by the performance benefit of avoiding the above-mentioned hold ups for dependent instructions.

### SUMMARY

At least some examples of the present technique provide an apparatus, comprising
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation counter indicating a number of times a value prediction entry associated with the target instruction has been allocated to the value prediction storage.

At least some examples of the present technique provide a system comprising:
the apparatus described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples provide a method, comprising
storing a plurality of value prediction entries in value prediction storage, each value prediction entry providing a data value prediction associated with a corresponding instruction;
providing a value prediction blocklist identifying one or more blocked instructions;
controlling whether to allocate a given value prediction entry associated with a given instruction to the value prediction storage in dependence on whether the given instruction is identified as a blocked instruction by the value prediction blocklist; and
determining whether to add a target instruction to the value prediction blocklist in dependence on an allocation counter indicating a number of times a value prediction entry associated with the target instruction has been allocated to the value prediction storage.

At least some examples provide computer-readable code for fabrication of an apparatus comprising:
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation counter indicating a number of times a value prediction entry associated with the target instruction has been allocated to the value prediction storage.

The computer-readable code may be stored on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising value prediction circuitry;

FIG. 2 illustrates how value prediction can increase instruction-level parallelism by breaking dependencies between instructions;

FIG. 3 illustrates a method for data value prediction;

FIG. 4 illustrates value prediction storage, a value prediction blocklist, and blocklist training storage;

FIG. 5 illustrates a method of controlling allocation of value prediction entries in the value prediction storage;

FIG. 6 illustrates a method of controlling allocation of entries in the value prediction blocklist;

FIG. 7 illustrates a tagged-geometric (TAGE) arrangement of value prediction tables; and

FIG. 8 illustrates a system and a chip-containing product.

### DESCRIPTION OF EXAMPLES

An apparatus has value prediction storage comprising a plurality of value prediction entries. Each value prediction entry provides a data value prediction associated with a corresponding instruction. The data value prediction may for example comprise a previously observed data value outcome of the corresponding instruction (e.g., a value previously loaded by a particular load instruction). In some examples, value prediction entries may be associated with a particular instance of a corresponding instruction, and hence several value prediction entries may be provided for different instances of an instruction at a particular memory address.

Providing value prediction storage can enable data value predictions to be made for instructions in a program. For example, the value prediction storage can be looked up based on information identifying an instruction in the program (e.g., a load instruction to load a data value from a location in memory) and if a corresponding value prediction entry is identified in the value prediction storage, then the data value prediction provided by that value prediction entry can be used as a predicted outcome of the instruction for executing subsequent instructions (e.g., instructions making use of a value loaded by a load instruction can use the predicted load value rather than waiting for the true load value to be returned from memory). This can improve performance by breaking dependency chains between instructions, allowing later dependent instructions to be executed before the correct outcome of an earlier instruction is known. Predicted values of instructions can be confirmed later to guarantee correct execution (with execution being rewound if the prediction was incorrect).

The given instruction whose result data value is predicted could be any instruction which generates a value for a given destination register which can be referenced as a source operand by a dependent instruction. For example, the given instruction could be an arithmetic/logical instruction for which the processing circuitry performs an arithmetic/logical operation to generate the result data value. The given instruction could also be a load instruction which causes the processing circuitry to issue a load request to a cache or memory system to cause the result data value to be loaded to a given destination register.

The value prediction storage may enable observed value outcomes of instructions to be tracked over time, with predictions being made in some examples only when a particular outcome has been observed enough times to have a high confidence that the prediction is correct.

One of the challenges associated with value prediction is that a large number of instructions do not exhibit stable results which can be predicted using the value prediction storage. Many instructions may have a data outcome which changes over time (e.g., the value loaded by a load instruction may change throughout a program), and therefore for many instructions a previously observed data value recorded in the value prediction storage may not provide a good prediction. In some implementations, only around 10-30% of instructions may have a behaviour which is stable enough to be predicted using the value prediction storage.

The value prediction storage has a finite size and, to meet area and power requirements, the size of the value prediction storage may be limited such that all possible value prediction entries cannot be stored in the value prediction storage. When allocating new value prediction entries, previous value prediction entries may therefore need to be invalidated. However, a large number of newly allocated value prediction entries may be associated with unstable instructions (for which data value predictions cannot be made, as discussed above) and therefore the value prediction storage may undergo significant thrashing whereby potentially useful value prediction entries are evicted to make space for value prediction entries having a high likelihood of not being useful. Such thrashing limits the efficiency and coverage of the value prediction storage, and the process of continuously replacing value prediction entries can also be associated with a high power cost.

According to examples of the present techniques, the apparatus comprises a value prediction blocklist, and value prediction allocation circuitry configured to control allocation of value prediction entries in the value prediction storage in dependence on the value prediction blocklist.

The value prediction blocklist identifies one or more blocked instructions, and the value prediction allocation circuitry is configured to control whether to allocate a given value prediction entry associated with a given instruction to the value prediction storage in dependence on whether the given instruction is identified as a blocked instruction by the value prediction blocklist. For example, if the given instruction is identified as a blocked instruction by the value prediction blocklist, then the allocation circuitry may determine that a value prediction entry should not be allocated for the given instruction (optionally subject to exceptions).

Blocklist allocation circuitry is configured to determine whether to add a target instruction to the value prediction blocklist in dependence on an allocation count indicating a number of times a value prediction entry associated with the target instruction has been allocated to the value prediction storage.

The inventor has realised that certain instructions may be particularly responsible for the thrashing discussed above, and causing pollution of the value prediction storage. For example, value prediction entries associated with certain instructions may be repeatedly allocated into the value prediction storage, and hence be responsible for eviction of a large number of potentially useful value prediction entries. Such instructions may for example appear to be promising candidates for value prediction, and may hence meet certain requirements for allocation into the value prediction storage, which may lead to value prediction entries associated with those instructions being allocated into the value prediction storage. In some examples, the value prediction storage may permit multiple value prediction entries to be stored at the same time in association with the same corresponding instruction, and in such examples there may be certain instructions having characteristics which may result in a large number of value prediction entries being stored in the value prediction storage in association with those instructions.

Hence, there may be certain instructions which are particularly associated with pollution of the value prediction storage. The value prediction blocklist provides a lightweight mechanism for identifying such instructions so that the allocation circuitry can suppress allocation of value prediction entries associated with such instructions in the value prediction storage.

Use of the value prediction blocklist can reduce the problems discussed above. In particular, by reducing allocation of value prediction entries associated with particularly polluting instructions, this can increase storage space in the value prediction storage available to store value prediction entries associated with other instructions which may prove more useful for value prediction, meaning that there may be a higher likelihood of the value prediction storage containing a value prediction entry for an instruction which can be predicted. This can therefore increase coverage of the value predictor, where coverage may be defined as a proportion of potentially predictable instructions which are successfully predicted. Use of the value prediction blocklist can also reduce power utilisation of the value prediction storage by reducing an overall number of evictions and allocations of value prediction entries in the value prediction storage.

Different examples of the blocklist allocation circuitry may apply different approaches for using an allocation count to determine when to allocate a target instruction to the value prediction blocklist. In some examples, the blocklist allocation circuitry may apply an allocation threshold to determine whether to allocate the given instruction to the value prediction blocklist, where the allocation circuitry may determine whether to allocate the target instruction to the blocklist in dependence on whether or not the allocation count exceeds the allocation threshold. The allocation threshold may be static (e.g., hardwired for a particular implementation), or it may be dynamic and subject to change during processing, such as in dependence on observed levels of eviction within the value prediction storage. Other examples may use different approaches for selecting instructions for the blocklist, such as selecting the N instructions (or in some examples, the N instructions meeting further conditions discussed below) having the highest allocation counts for allocation to the value prediction blocklist.

In some examples, the blocklist allocation circuitry may determine which instructions to allocate to the value prediction blocklist in dependence on the allocation count alone. However, there may be certain instructions which are responsible for allocating a large number of value prediction entries in the value prediction storage, but which may be predictable and hence for which the allocated value prediction entries may include useful value prediction entries. Whilst such instructions may cause allocation of a large number of value prediction entries, those value prediction entries may be useful for value prediction, and hence value prediction coverage may be improved overall by omitting those instructions from the value prediction blocklist. Therefore, in some examples, the allocation circuitry may be configured to determine whether to add the target instruction to the value prediction blocklist in dependence on a prediction count indicating a number of times value prediction circuitry has predicted an outcome of the target instruction using the value prediction storage. This may reduce the likelihood of predictable instructions being added to the blocklist, and hence may increase overall value predictor coverage.

The blocklist allocation circuitry may use several different approaches for deciding whether to allocate the target instruction to the blocklist depending on the prediction count. In some examples, the allocation circuitry may suppress an instruction being added to the blocklist if any value predictions have been made using a value prediction entry associated with that instruction (i.e., if the prediction count is greater than zero). Value predictions may only be made when a value prediction entry indicates a value prediction with a high degree of confidence, and hence if any value predictions are made for a particular instruction then this may indicate that the instruction is predictable and hence should not be added to the value prediction blocklist. However, in other examples a particular instruction might reach a high enough level of confidence for some value predictions to be made, but a number of predictions made for the instruction may be relatively low and hence addition of the instruction to the blocklist may nevertheless be justified. In some examples, the blocklist allocation circuitry may use a static prediction count threshold for deciding whether to suppress the instruction being added to the value prediction blocklist. In other examples, the blocklist allocation circuitry may determine whether to add the instruction to the blocklist depending on a comparison between the allocation count and the prediction count, e.g., having a dynamic prediction count threshold which increases with allocation count, so that instructions have a higher prediction count threshold (i.e., they have to be more useful) when those instructions are associated with a larger number of allocations in the value prediction storage.

In some examples, each value prediction entry in the value prediction storage may be configured to provide a confidence indication associated with the data value prediction provided by that value prediction entry. Such confidence values may be incremented in response to observing outcomes of the corresponding instruction which agree with the data value prediction, and may be decremented in response to observing outcomes which disagree with the data value prediction. In some examples, the blocklist allocation circuitry may be configured to determine whether to add the target instruction to the value prediction blocklist in dependence on a given confidence indication provided by a value prediction entry associated with the target instruction.

For example, similar to the prediction count, a confidence indication associated with the target instruction may indicate a potential value of permitting value prediction entries associated with the target instruction to be allocated to the value prediction storage. Therefore, in some examples, the blocklist allocation circuitry may determine that despite having a high allocation count, a given instruction should nevertheless not be added to the value prediction blocklist if the given confidence indication is high enough. For example, a confidence threshold may be used for determining whether to allocate the target instruction to the value prediction blocklist, wherein the allocation circuitry may determine not to add the target instruction to the blocklist if the given confidence indication exceeds the confidence threshold. The confidence threshold may be static or dynamic, for example it may depend on the allocation count for a given instruction.

In some examples, the value prediction storage may only permit a single value prediction entry to be stored for each instruction. In this case, the given confidence indication may be the only confidence indication associated with the target instruction. However, in other examples the value prediction storage may be configured to permit storage of a plurality of value prediction entries associated with the target instruction. In such examples, the given confidence indication may comprise a highest confidence indication provided by any value prediction entry associated with the target instruction. Hence, the blocklist allocation circuitry may determine whether the most promising value prediction entry associated with the target instruction has a high enough confidence indication (i.e., is likely enough to provide useful value predictions) to justify the target instruction not being added to the value prediction blocklist when the allocation count would otherwise be high enough to justify the target instruction being added to the value prediction blocklist.

As discussed above, the value prediction storage may be used by value prediction circuitry to predict outcomes of instructions. In some examples, the apparatus therefore comprises value prediction circuitry responsive to a pending instruction to perform a lookup in the value prediction storage, and in response to identifying a matching value prediction entry corresponding to the target instruction for which the confidence indication exceeds a prediction threshold, the value prediction circuitry is configured to provide the data value prediction of the matching value prediction entry as a predicted outcome of the pending instruction.

In some examples, the blocklist allocation circuitry may be configured to determine whether to add the target instruction to the value prediction blocklist in dependence on whether the given confidence indication exceeds the prediction threshold. Therefore, the allocation circuitry may determine whether to add the target instruction to the value prediction blocklist depending on whether there is a value prediction entry associated with that instruction which has reached a sufficient confidence level to enable value predictions to be made. This can result in improved value prediction coverage by reducing the likelihood of allocation of useful value prediction entries from being blocked by the value prediction blocklist.

In some examples, the value prediction allocation circuitry may be configured to permit allocation of a given value prediction entry for the given instruction, independent of whether the given instruction is identified as a blocked instruction by the value prediction blocklist, if the given value prediction entry can be allocated to the value prediction storage without evicting another value prediction entry. That is, if there are some unused entries in the value prediction storage which may accommodate the given value prediction entry, then the allocation circuitry may be permitted to allocate the given value prediction entry to the value prediction storage even if the given value prediction entry provides a data value prediction for a blocked instruction. Hence, the value prediction blocklist may only identify instructions which are blocked from evicting another value prediction entry from the value prediction storage.

As discussed above, each value prediction entry provides a data value prediction associated with a corresponding instruction. An instruction may be identified at least by a tag based on the memory address at which the instruction is stored in memory. However, a given instruction may be executed in various different contexts, for which a predicted data value may differ. For example, the same instruction may be accessed via various different routes through a program, and each route might have a different (and potentially predictable) data value outcome for the instruction. Therefore, in some examples, at least a subset of the plurality of value prediction entries may be configured to associate a given data value prediction with a particular instance of the corresponding instruction identified by some contextual information. The value prediction storage may comprise two or more value prediction entries associated with the same instruction and different instruction contexts, which can provide independent data value predictions.

In examples where value prediction storage provides value prediction entries associated with instruction context, there is a possibility for a single instruction to be associated with a large number of value prediction entries simultaneously present in the value prediction storage. For example, a piece of code may include the same instruction executed in several different contexts, and hence that instruction may cause a large number of allocations of value prediction entries, and hence be a potential source of significant pollution within the value prediction storage. For example, a subroutine may be called from various different points in a program, and hence instructions in the subroutine may be executed in many different instruction contexts.

The value prediction storage pollution associated with such instructions may be particularly significant if that instruction is difficult to predict, as a single instruction could potentially lead to a large number of useless entries being allocated to the value prediction storage. Examples supporting value prediction entries associated with an instruction context may therefore particularly benefit from the use of the value prediction blocklist, as the value prediction blocklist can identify those instructions most likely to cause a large number of value prediction entries to be allocated (e.g., instructions within a subroutine).

The instruction context may be indicated in various different ways. In some examples, the corresponding instruction context may comprise a branch history. The branch history for a particular value prediction entry indicates branch outcomes of branch instructions executed prior to the corresponding instruction associated with that value prediction entry. Branch instructions can cause program flow to jump to different addresses, and may be optionally taken or not taken. A history of recent branch outcomes (i.e., whether each of the N most recent branches were taken or not taken) therefore identifies a particular path which has been taken through a program to reach the corresponding instruction, and can be used to distinguish different instances of an instruction appearing at different points in a program. As the outcomes may be different (but in some cases nevertheless predictable) for different instances of an instruction with different branch histories, associating value prediction entries with a branch history allows different instances of the instruction to be predicted separately. The same instruction with a different branch history may therefore be treated almost as an entirely separate instruction.

Hence, an apparatus which provides value prediction entries associated with a branch history may particularly suffer from the problem that a large number of value prediction entries may be allocated for certain instructions and the various different branch histories in which those instructions might be executed. As discussed above, instructions within a subroutine may be executed at various different points in a program and therefore may be executed with many different branch histories, potentially leading to a large number of value prediction entries. Use of a blocklist may therefore be particularly useful when branch history is used to provide instruction context.

In some examples, the value prediction storage may store value prediction entries associated with different branch history signatures, such as different lengths of branch history or different combinations of branch history bits. For example, the value prediction storage could comprise a plurality of value prediction tables, where value prediction entries in at least a subset of the plurality of value prediction tables are associated with a combination of the corresponding instruction and a corresponding branch history, and two or more value prediction tables comprise value prediction entries associated with different lengths of branch history. Such an arrangement may be present in a tagged geometric (TAGE) value predictor comprising a plurality of TAGE tables. When a lookup hits in any of the TAGE tables, a prediction may be generated from the entry looked up using the longest length of branch history information. That is, a TAGE predictor may preferentially select a value prediction based on an entry hit in a table indexed based on a longer history information, but if no hit is identified in the longer history tables then a prediction from a table indexed based on a shorter length of history can be used instead. This approach can provide high performance because TAGE predictors can remove the need to compromise between shorter history (which is more likely to hit against an entry but for which the prediction is less accurate) and longer history (which is less likely to hit against an entry but if it does then the prediction is more accurate) as both short and long history can be used to look up different tables.

Whilst supporting value prediction entries associated with different lengths of branch history or different branch history signatures can improve coverage, it may also lead to a large number of value prediction entries being allocated to the value prediction storage in association with certain instructions. For example, several value prediction entries may be allocated across several different lengths of branch history for a given instruction, which means that individual instructions may be associated with pollution of several entries in the value prediction storage.

As discussed above, although value prediction entries may be associated with a combination of an instruction and an instruction context, in some examples, the value prediction blocklist may be configured to identify instructions independent from the instruction context. That is, the value prediction blocklist may identify that a certain instruction is a blocked instruction regardless of the instruction context in which it is executed. This enables a single entry in the value prediction blocklist to be used to block various instances of a given instruction, and hence provides a lightweight mechanism for reducing pollution of the value prediction storage.

The value prediction blocklist may identify a blocked instruction in various ways. In some examples, the value prediction blocklist may be configured to identify a given blocked instruction using a tag value based on a memory addresses of the given blocked instruction. The memory address of the location in memory storing the given instruction can be used to uniquely identify the instruction. In some examples, the tag value may be shorter that the memory address itself (e.g., based on a number of least significant bits of the address or a hash function of the memory address) to reduce a storage requirement of the value prediction blocklist.

In some examples, the value prediction blocklist comprises a plurality of blocklist entries, each blocklist entry identifying a blocked instruction. The total number of blocklist entries may be relatively small compared to a total number of instructions in a typical program. For example, in illustrative examples the blocklist could contain 16 or 32 entries. The value prediction blocklist may also have a replacement policy favouring eviction of older blocklist entries from the blocklist to accommodate allocation of new entries in the value prediction blocklist. For example, the allocation policy may simply choose to evict the blocklist entry which has been in the value prediction blocklist for longest (e.g., based on information indicating the relative age of the blocklist entries), or could also consider other factors (such as whether or not lookups in the blocklist have hit against an entry) in addition to favouring eviction of older blocklist entries.

Hence, the blocklist may contain a relatively small number of entries which are turned over relatively frequently so a given instruction may not permanently remain in the value prediction blocklist. This allows instructions to become unblocked so that value prediction entries can be allocated to enable value predictions to be made for an instruction during certain portions of a program even if that instruction is responsible for pollution, and hence blocked from the value prediction storage, in other portions of the program. This is based on the observation that the degree to which an instruction may be responsible for pollution of the value prediction storage may be a temporal behaviour which may affect different portions of a program in different ways. For instance, while a first portion of a program may call a certain subroutine frequently (and hence instructions in that subroutine may cause pollution in the value prediction storage), that subroutine may not be called in a different portion of the program.

In some examples, the decision regarding whether to allocate the given value prediction entry to the value prediction storage may be made in response to observing an outcome of the given instruction, and in some examples responsive to a determination that the value prediction storage does not already contain a value prediction entry associated with the given instruction (or, in some examples, does not contain an entry associated with the given instruction in the same instruction context). Hence, the value prediction allocation circuitry may perform a lookup in the value prediction blocklist for a particular instruction in response to observing the outcome of that instruction, to determine whether to allocate a value prediction entry for that instruction.

In some examples, the value prediction allocation circuitry may also determine whether to allocate a value prediction entry to the value prediction storage in dependence on certain initial filtering steps. Whilst initial filtering may prevent a number of instructions from being allocated to the value prediction storage, there may be certain instructions having attributes (e.g., relatively predictable outcomes) which enable those instructions to pass the initial filtering steps. However, certain instructions may pass the initial filtering steps but nevertheless not provide useful value predictions (e.g., the outcome is predictable enough to pass the filtering, but not predictable enough to generate value predictions), and such instructions may be particularly responsible for pollution of the value prediction storage. The value prediction blocklist enables such instructions to be identified as blocked instructions based on the allocation count, independent from any initial filtering steps, and hence provides a mechanism for catching instructions which may cause pollution of the value prediction storage.

As mentioned above, in some examples, each value prediction entry is configured to provide a confidence indication associated with the data value prediction. In some examples, training circuitry is configured to increment the confidence indication in response to determining that an observed data value outcome of the corresponding instruction matches the data value prediction.

As discussed above, various instructions may be subject to value prediction. In some examples, the value prediction storage may be configured to provide value prediction entries associated with load instructions to enable prediction of data value outcomes of load instructions. Prediction of load instructions may be particularly beneficial, as load instructions can take a long time to execute, particularly if the requested data is not present in a cache and must be retrieved from memory.

Various approaches can be used to determine allocation counts for instructions when deciding whether to add those instructions to the value prediction blocklist. In some examples, the apparatus may comprise blocklist training storage comprising a plurality of blocklist training entries. The blocklist training storage may be used by allocation circuitry to determine which instructions should be allocated to the value prediction blocklist. For instance, each blocklist training entry may provide at least an allocation count for an associated instruction, where as described above the allocation count is considered by the allocation circuitry when deciding whether to allocate an instruction to the blocklist. Blocklist training entries may also store further information regarding an associated instruction, such as a number of value predictions made for that instruction and/or a confidence indication associated with that instruction, which can be used to determine which instructions to add to the value prediction blocklist.

The approach used to select instructions for allocation to the blocklist training storage is not particularly limited. In some examples, an entry may be allocated to the blocklist training storage for an instruction when a value prediction entry corresponding to that instruction is first allocated to the value prediction storage (and hence when the allocation count is one).

Specific examples will now be described with reference to the drawings.

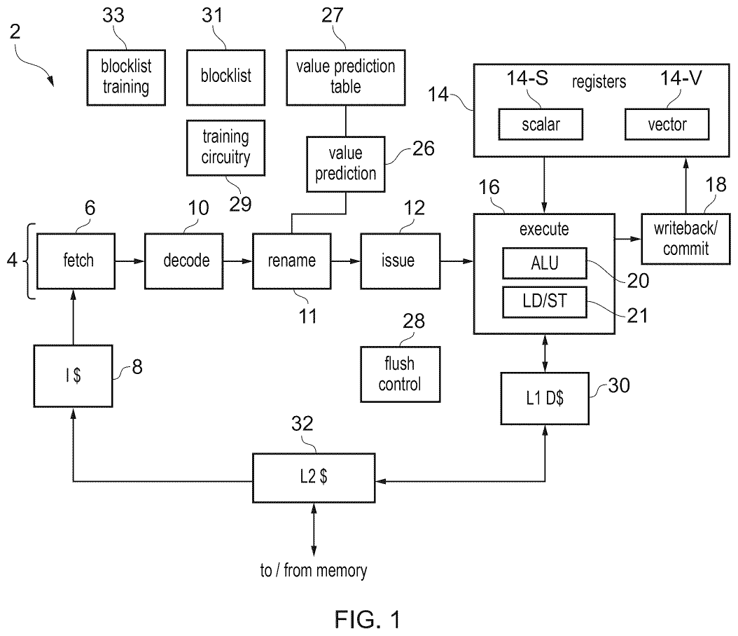

FIG. 1 schematically illustrates an example of a data processing apparatus 2. The data processing apparatus has a processing pipeline 4 which includes a number of pipeline stages. In this example, the pipeline stages include:
a fetch stage 6 for fetching instructions from an instruction cache 8.
a decode stage 10 for decoding the fetched program instructions to generate micro-operations (decoded instructions) to be processed by remaining stages of the pipeline.
a rename stage 11 for performing register renaming to map logical register identifiers specified by program instructions or micro-operations to physical register identifiers identifying physical registers in a register file 14.
an issue stage 12 for checking whether operands required for the micro-operations are available in the register file 14 and issuing micro-operations for execution once the required operands for a given micro-operation are available (or are guaranteed to be available by the time the micro-operation reaches the relevant execution unit).
an execute stage 16 for executing data processing operations corresponding to the micro-operations, by processing operands read from the register file 14 to generate result values.
a writeback/commit stage 18 for writing the results of the processing back to the register file 14 and committing instructions once they are guaranteed to be correctly executed.

It will be appreciated that this is merely one example of possible pipeline architecture, and other systems may have additional stages or a different configuration of stages.

The execute stage 16 includes a number of execution units, for executing different classes of processing operation. For example the execution units may include an arithmetic/logic unit (ALU) 20 for performing arithmetic or logical operations on scalar operands read from the registers 14; and a load/store unit 21 for performing load/store operations to access data in a memory system 8, 30, 32. In this example, the memory system includes a level one data cache 30, the level one instruction cache 8, a shared level two cache 32 and main system memory (not shown in FIG. 1). It will be appreciated that this is just one example of a possible memory hierarchy and other arrangements of caches can be provided. Further examples of execution unit (not shown in FIG. 1 for conciseness) can include a branch unit for executing branch instructions, a floating-point unit for performing operations on numbers represented in a floating-point format, etc. The ALU 20 shown in FIG. 1 could be implemented with separate scalar ALU and vector ALU execution units for performing scalar and vector operations, with the scalar ALU processing scalar operands stored in scalar registers 14-S and the vector ALU processing vector operands stored in vector registers 14-V (in some examples the vector registers 14-V and scalar registers 14-S may correspond to separate instances of register files 14).

The specific types of execution unit discussed above for the execute stage 16 are just one example, and other implementations may have a different set of execution units or could include multiple instances of the same type of execution unit so that multiple micro-operations of the same type can be handled in parallel. It is not essential for the apparatus to support both scalar and vector processing (e.g. some examples may not support the vector ALU and vector registers 14-V). It will be appreciated that FIG. 1 is merely a simplified representation of some components of a possible processor pipeline architecture, and the processor may include many other elements not illustrated for conciseness.

The apparatus 2 also includes value prediction circuitry 26 used to generate a data value prediction representing a predicted result data value expected to be obtained by a given instruction, before that instruction has actually been processed by the execute stage 16. For example, an ALU instruction to be processed by the ALU 20 could have the result of the ALU operation (e.g. add, subtract, multiply, divide, square root, shift, AND, OR, etc.) predicted by the value prediction circuitry 26, or the load target data to be loaded by the load/store unit 21 in response to a load instruction could be predicted before the load data is actually returned from the memory system. The value prediction circuitry 26 uses one or more value prediction tables 27 (collectively referred to as value prediction storage) to store prediction information learnt from previous instruction execution that can be used to predict the result data value for an instruction on a subsequent occasion. When a value prediction is made for a given instruction, dependent instructions (instructions which have a source operand which depends directly or indirectly on the result data value of the given instruction) can execute earlier as the dependency on the given instruction can be broken.

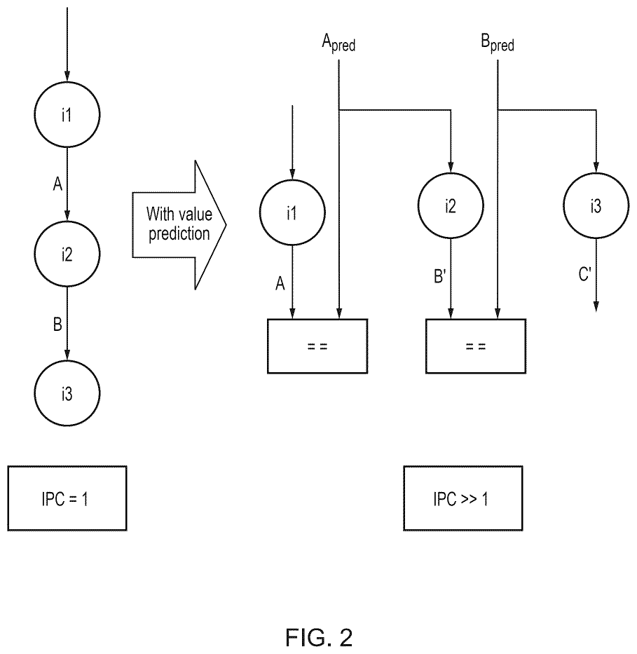

FIG. 2 illustrates the principle of data value prediction. The left-hand part of FIG. 2 illustrates execution of a sequence of instructions in the absence of value prediction, with a second instruction i2 being dependent on the result data value A of a first instruction i1, and a third instruction i3 being dependent on the result data value B of the second instruction i2 (hence, relative to instruction i1, both instructions i2 and i3 are dependent instructions which depend on instruction i1). In the absence of value prediction, the dependencies would constrain these instructions to be executed sequentially, so in the absence of any other independent instructions which could be executed in parallel with the instructions i1-i3, the number of instructions executed per cycle (IPC) would be 1.

The right-hand part of FIG. 2 illustrates how the same instructions i1-i3 can be executed in parallel when value prediction circuitry 26 is used to predict the result data values A and B of instructions i1 and i2. This allows instruction i2 to execute in parallel with instruction i1, based on an operand corresponding to the predicted result data value A_{pred} for instruction i1. Similarly, instruction i3 can execute in parallel with instruction i2, based on an operand corresponding to the predicted result data value B_{pred} for instruction i2. This generates speculative results B′ and C′ for instructions i2 and i3. Subsequently, once instruction i1 actually completes, comparison logic can compare the actual result data value A of instruction i1 with the predicted result data value A_{pred} for instruction i1, and signal a misprediction if there is a mismatch. Similarly, comparison logic can compare the actual result data value B′ of instruction i1 with the predicted result data value B_{pred} for instruction i1, and signal a misprediction if there is a mismatch. If the value predictions are correct, the parallel execution of instructions i1-i3 gives an IPC greater than 1, speeding up performance compared to the execution in absence of value prediction.

As shown in FIG. 1, flush control circuitry 28 is provided to control flushing of instructions and micro-operations from the processing pipeline 4 if a misprediction is detected (either based on an incorrect branch prediction by branch predictor 19, or based on an incorrect value prediction by value prediction circuitry 26). When a flush is required, the flush control circuitry 28 determines the point of program flow associated with the misprediction, and triggers a flush of all instructions/micro-operations younger (later in program order) than the misprediction point, so that those instructions can be re-fetched by the fetch stage 6 and processed once more based on the correct outcome for the mispredicted instruction.

The value prediction table 27 comprises a plurality of value prediction entries. Each value prediction entry is associated with a particular instruction, which may be identified using the memory address of that instruction. For example, entries may be tagged with a portion of the memory address of the associated instruction, which can be used to identify an entry corresponding to a particular instruction. For example, when a program counter (PC) register has a particular PC value indicating the memory address of the next instruction in a program, the PC value can be used to look up the value prediction table to identify which value prediction entry corresponds to the next instruction. Value prediction entries may also be associated with further contextual information for an instruction, which can allow two or more different value prediction entries to be provided for the same instruction when executed in different contexts, as the same instruction may produce different data values depending on the context in which it is executed. For example, as will be discussed in greater detail below, entries may also be identified in dependence on a branch history of recent branch instructions (e.g., an M-bit value with each bit indicating whether a respective one of the most recent M branches was taken or not taken). The value prediction entries also provide the data value prediction itself, and may also provide information indicating a degree of confidence that the value prediction is correct. The confidence indication may for example be incremented when the instruction (in the same execution context) is observed to have the same outcome as indicated in the value prediction entry, and decremented if the instruction is observed to have a different outcome to the outcome recorded in the value prediction entry.

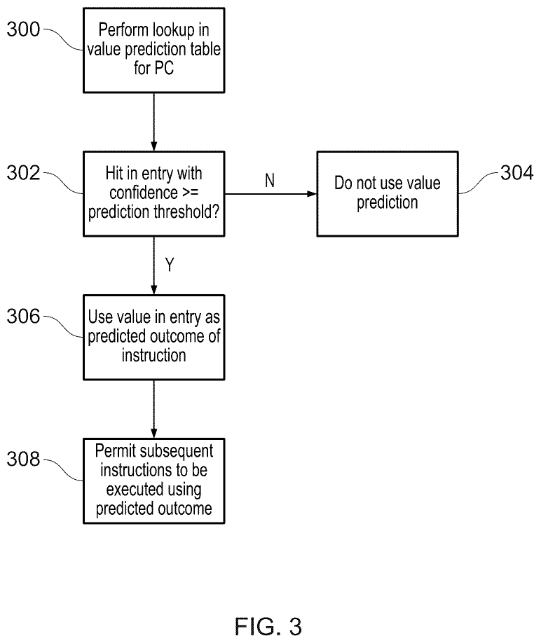

FIG. 3 is a flow diagram illustrating a method of performing data value prediction. At step 300, value prediction circuitry 26 performs a lookup in the value prediction storage 27 based on information identifying a target instruction to be executed by the execute circuitry 16. For example, the value prediction circuitry 26 may use a value of the program counter register to identify a memory address of the target instruction for looking up the value prediction table, and may also use other context information associated with the particular instance of the target instruction (such as a branch history).

At step 302, it is determined whether the value protection storage lookup hits against an entry associated with the target instruction and providing a data value prediction associated with a confidence equal to or higher than a prediction threshold required to make predictions in respect of the target instruction.

If either: a value prediction entry is not identified, or a value prediction entry is identified having a confidence below the prediction threshold, then at step 304 value prediction is not used for the target instruction. Instead, the target instruction is executed as normal and any dependent instructions are delayed (i.e., not issued) until the target instruction has produced an output, and are then executed using the output of the target instruction.

In contrast, if a value prediction entry is identified and provides a data value prediction having a confidence above the prediction threshold, then at step 306 the data value prediction is used as a predicted outcome of the target instruction. Hence, at step 308, any dependent instructions may be issued before the target instruction has been executed, using the predicted outcome of the target instruction as a source operand. In due course, the target instruction is executed (e.g., off the critical path) and the correct outcome of the target instruction is compared against the predicted outcome to determine whether the prediction was correct and hence whether a pipeline flush is required.

As shown in FIG. 1, the apparatus comprises training circuitry 29 including value prediction allocation circuitry and blocklist allocation circuitry. The value prediction allocation circuitry is configured to control allocation of value prediction entries in the value prediction storage 27. In some examples, the allocation circuitry may have a general allocation policy seeking to allocate a value prediction entry in the value prediction storage 27 in response to observing an outcome for a particular instance of an instruction, and determining that the value prediction storage does not currently provide a value prediction entry corresponding to that observed instance of the instruction (e.g. the instruction in the same particular context).

However, certain instructions may be responsible for allocation of a large number of value prediction entries in the value prediction storage (e.g., certain instructions may cause one or more value prediction entries to be repeatedly allocated to the value prediction storage even if such entries are evicted, or may cause multiple entries to be simultaneously stored in the value prediction storage). Particularly when such instructions are difficult to predict (and hence when allocation of such value prediction entries may have limited value), such instructions may be responsible for evicting large numbers of useful entries from the value prediction storage to be replaced with less useful value prediction entries. Certain instructions may therefore be particularly responsible for reducing coverage of the value prediction circuitry.

Therefore, in the examples discussed below, the apparatus also comprises a value prediction blocklist 31 to be used by the value prediction allocation circuitry when deciding whether to allocate a value prediction entry for a target instruction in the value prediction storage. The value prediction blocklist 31 identifies a number of blocked instructions. When deciding whether to allocate a value prediction entry for a target instruction, the value prediction allocation circuitry may reference the blocklist 31 and determine not to allocate the value prediction entry if the target instruction is identified as a blocked instruction by the value prediction blocklist 31.

Instructions which have been identified as particular contributors to pollution of the value prediction storage may be added to the value prediction blocklist. In particular, certain instructions may be tracked (e.g., in entries of blocklist training storage 33) to provide an allocation count indicating a number of times a value prediction entry associated with a particular instruction has been allocated to the value prediction storage. When the allocation count meets a certain allocation threshold, the corresponding instruction may be treated as a candidate for addition to the value prediction blocklist and may be added to the blocklist unless a reason is determined not to do so (e.g., it may be determined that the large number of value prediction entries associated with that instruction are in fact useful for value prediction).

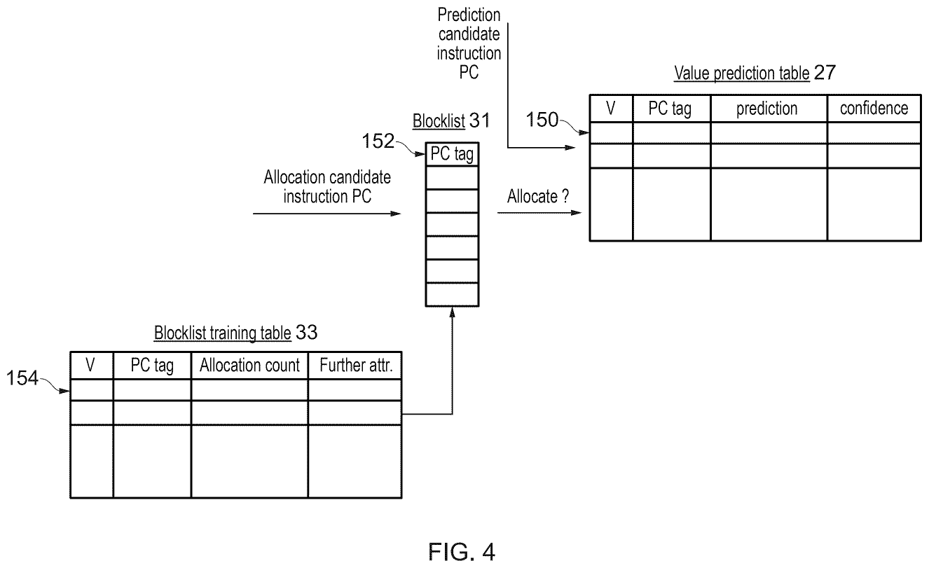

FIG. 4 illustrates the value prediction allocation blocklist 31, blocklist training storage 33, and value prediction storage 27 in greater detail. As mentioned above, the value prediction storage 27 provides a plurality of value prediction entries 150. Each value prediction entry may provide various fields, including a valid field (V) indicating whether the entry is a valid value prediction entry, a memory address tag field (PC tag) providing a tag value used to associate the value prediction entry 150 with a particular instruction at the memory address, a data value prediction field providing a predicted data value outcome of the corresponding instance of the instruction, and a confidence field indicating a level of confidence in the data value prediction being correct. It will be appreciated that although not shown in FIG. 4, there may be other information indicated in the value prediction entries 150, such as contextual information distinguishing different instances of the same instruction (having the same value in the PC tag field). As described in FIG. 3, the value prediction table 27 may be looked up to provide value predictions for instructions during execution of software.

As shown in FIG. 4, the value prediction blocklist 31 provides a number of blocklist entries 152. Each valid blocklist entry 152 identifies a blocked instruction. For example, a blocklist entry 152 may identify a blocked instruction using a tag (‘PC tag’) based on the memory address of the instruction. Whilst the PC tag could be the entire memory address, in some examples one or more bits of the memory address which are not required to uniquely identify the blocked instruction may be excluded from the PC tag (e.g., one or more most significant bits which are the same for all addresses in the program, and/or one or more least significant bits which identify positions within a cache line). Although not shown in FIG. 4, the blocklist entries may also provide a valid field and may provide additional information for each blocked instruction, such as age information used for an eviction policy.

FIG. 4 also illustrates an example of the blocklist training table 33. The blocklist training table 33 provides a plurality of blocklist training entries 154. Each blocklist training entry may provide various fields, including a valid field (V) indicating whether the entry is a valid value prediction entry, a memory address tag field (PC tag) providing a tag value used to associate the blocklist training entry 154 with a particular instruction, and an allocation count field tracking a number of times a value prediction entry has been allocated in the value prediction storage in association with the instruction associated with the blocklist training entry.

In some examples, the allocation count may indicate a number of times a value prediction entry associated with the instruction has been allocated in a subset of the value prediction storage. For example, the value prediction storage may include a plurality of tables, and the allocation count may represent a number of allocations within a subset of the plurality of tables associated with the instruction.

The plurality of blocklist training entries 154 may also identify further information used when deciding whether to allocate a particular instruction to the blocklist. For example, the blocklist training entries 154 may provide a prediction count field indicating a number of times a data value prediction has been made using any value prediction entry associated with that instruction, and/or may provide a confidence field indicating a highest confidence of any value prediction entry associated with that instruction.

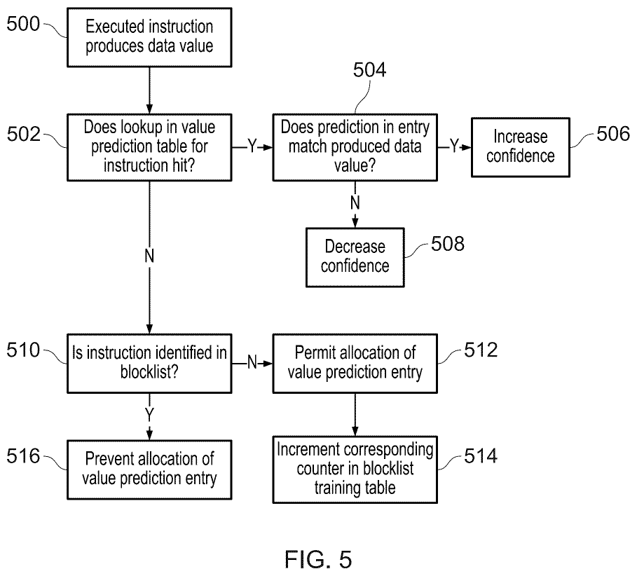

FIG. 5 is a flow diagram illustrating a method of controlling allocation in the value prediction storage 27 using a value prediction blocklist 31.

At step 500 an instruction is executed producing a data value outcome. The instruction could for example be a load instruction, and the data value may be the loaded data value returned from memory.

At step 502, the allocation circuitry performs a lookup in the value prediction storage to determine whether there is an existing value prediction entry corresponding to the observed instance of the instruction. If so, then at step 504 it is determined whether the observed outcome matches the data value prediction provided by the existing value prediction entry. If so, then at step 506 the confidence value associated with the data value prediction can be increased. If the observed data value disagrees with the stored data value prediction, the confidence value can be decreased at step 508.

If the allocation circuitry did not find an existing value prediction entry in the value prediction storage corresponding to the observed instance of the instruction, then at step 510 the allocation circuitry performs a lookup in the value prediction blocklist 31. For instance, the allocation circuitry may perform a lookup in the value prediction blocklist using a tag value calculated using the memory address of the instruction executed at step 500.

If the instruction is not identified as a blocked instruction by the blocklist (i.e., the lookup at step 510 resulted in a miss in the blocklist), then allocation of a value prediction entry corresponding to the instruction is permitted by the blocklist. At step 512 the allocation circuitry may therefore allocate a value prediction entry corresponding to the executed instruction in the value prediction storage. However, the allocation at step 512 may nevertheless be subject to additional filtering steps and hence in certain cases a value prediction entry may not necessarily be allocated in the value prediction storage due to failure of a further filtering step, even if that instructions is not identified as a blocked instruction by the blocklist.

When a value prediction entry corresponding to an instruction is allocated in the value prediction storage, an existing blocklist training entry corresponding to that instruction may be updated at step 514 to increment the allocation counter. If there is no existing blocklist training entry corresponding to the same instruction (same PC tag) as the allocated value prediction entry, then a new blocklist training entry can be allocated.

If at step 510 it is instead determined that the value prediction blocklist identifies the instruction as a blocked instruction (i.e., the blocklist lookup results in a hit), then at step 516 the allocation circuitry is prohibited from allocating a value prediction entry in the value prediction storage corresponding to the instruction.

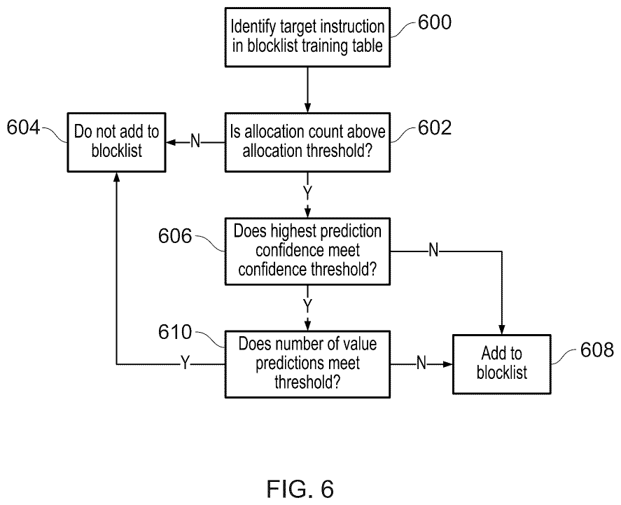

FIG. 6 is a flow diagram illustrating a method of selecting instructions for allocation to the value prediction blocklist 31 using the blocklist training table 33.

At step 600, allocation circuitry identifies a candidate instruction associated with an entry 154 of the blocklist training table 33. This process illustrated in FIG. 6 may for example be an ongoing process applied to each entry of the blocklist training table, or entries 154 may be selected at intervals.

At step 602 the allocation circuitry determines whether the allocation count, indicated by the blocklist training entry associated with the candidate instruction, is above an allocation threshold.

If the allocation count is not above the allocation threshold, then value prediction entries associated with the candidate instruction have not been allocated to the value prediction storage enough times for the candidate instruction to be added to the value prediction blocklist 31. Therefore, at step 604 the candidate instruction is not added to the blocklist.

If at step 602 it is determined that the allocation count is above the allocation threshold, then value prediction entries associated with the candidate instruction have been allocated to the value prediction storage enough times to justify adding the candidate instruction to the value prediction blocklist. However, if the value prediction entries may be useful for data value prediction then coverage of the value predictor may be improved by leaving the candidate instruction off the value prediction blocklist (and hence allowing further value prediction entries to be allocated for the candidate instruction).

Therefore, at step 606 the allocation circuitry determines which, of all value prediction entries currently stored in the value prediction storage and associated with the candidate instruction, is associated with the highest confidence indication, and whether that confidence indication meets a confidence threshold. If there are no value prediction entries currently associated with the candidate instruction then this step is automatically answered in the negative.

If the highest confidence value prediction entry associated with the candidate instruction does not meet the confidence threshold, then this suggests that the candidate instruction is not a good candidate for value prediction and hence does not justify the large number of value prediction entries it has caused to be allocated in the value prediction storage. Therefore, at step 608 the candidate instruction is added to the value prediction blocklist.

If the highest confidence value prediction entry does meet the confidence threshold, then at step 610 it is determined how many data value predictions have been made for the candidate instruction using the value prediction storage, and whether this number meets a prediction threshold.

If not, then this indicates that the performance improvement associated with storing value prediction entries associated with the candidate instruction does not justify the cost of storing the large number of value prediction entries associated with that instruction. This might be the case when an instruction has attributes which allow it to meet the confidence threshold (and any initial filtering steps), such as having a data value outcome which slowly changes over time and therefore appears stable over small windows of iterations. Therefore, in this case the candidate instruction may also be added to the value prediction blocklist.

However, if the number of data value predictions made using value prediction entries associated with the candidate instruction does meet the threshold then the candidate instruction is not added to the value prediction blocklist.

It will be appreciated that the steps 606 and 610 may be optional. In some examples, either one of the steps 606 and 610 may be used without the other.

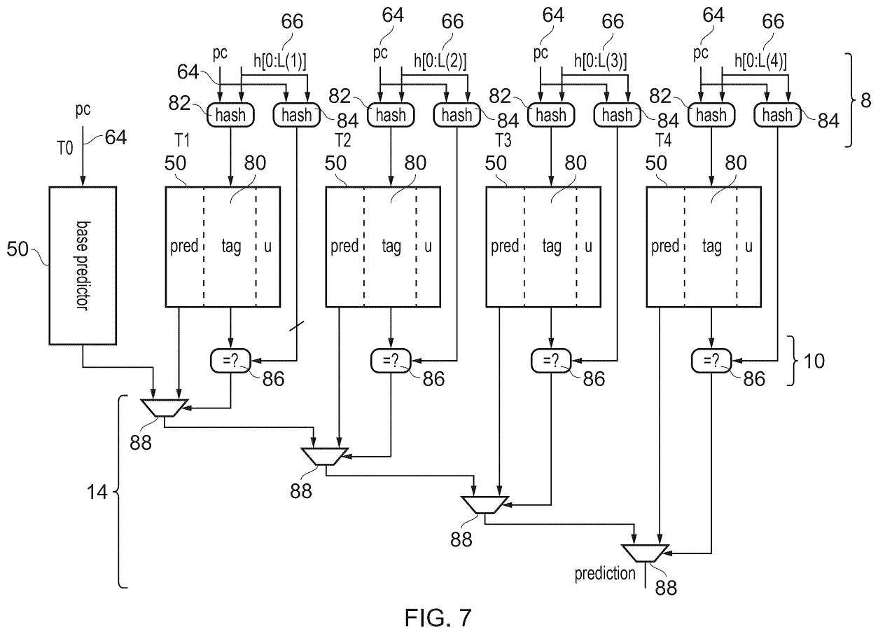

FIG. 7 illustrates a particular example of value prediction storage 27. In particular, FIG. 7 illustrates a tagged-geometric (TAGE) arrangement of value prediction tables 50. The prediction tables 50 include a base prediction table T0 and a number of tagged-geometric (TAGE) tables T1 to T4. While this example shows 4 TAGE tables for conciseness, it will be appreciated that the TAGE predictors could be provided with a larger number of tables if desired, e.g., 8 or 16. The base predictor T0 is looked up (e.g. indexed/tagged) based on the address of the instruction to be predicted alone, while the TAGE tables T1 to T4 are looked up based on a hash value generated by applying a hash function to the program counter address (PC) 64 and successively increasing lengths of history information 66, so that T1 uses a shorter sequence of history information compared to T2, T2 uses a shorter sequence of history information compared to T3, and so on. In this example T4 is the table which uses the longest sequence of history information. Each table provides a plurality of value prediction entries specifying a predicted data value for a corresponding instruction, in addition to a confidence indication representing a degree of confidence that the data value prediction is correct. Each entry also specifies a tag value 80 which is compared with a tag hash generated from the input lookup information for that table to detect whether the entry corresponds to the current block being looked up (the tag distinguishes between multiple blocks whose index hash values alias onto the same entry of the table). The lookup information generation circuitry 8 includes index hashing circuitry 82 for generating, based on the input lookup information, an index hash for indexing into a selected entry of the table, and tag hashing circuitry 84 for generating, based on the input lookup information, a tag hash value to be written to a newly allocated entry or for comparing with an existing entry's tag value 80 on a lookup, and the lookup circuitry 10 comprises comparison circuitry 86 for comparing the tag value 80 read out from a looked up entry with the calculated tag hash generated by the tag hashing circuitry 84 to determine whether a hit has been detected.

For a TAGE predictor, the value prediction circuitry 26 comprises a cascaded sequence of selection multiplexers 88 which select between the alternative predictions returned by any of the prediction tables 50 which generate a hit. The base predictor 50 may be used as a fall-back predictor in case none of the other TAGE tables generate a hit (a hit occurs when the tag in the looked up entry matches the tag hash generated based on the indexing information). The cascaded multiplexers are such that if the table T4 indexed with the longest sequence of history generates a hit then its prediction will be output as the data value prediction, but if it misses then if the preceding table T3 generates a hit then the T3 prediction will be output as the data value prediction, and so on, so that the prediction which gets selected is the prediction output by the table (among those tables which generated a hit) which corresponds to the longest sequence of history considered in the indexing. That is, any tables which miss are excluded from the selection, and among the remaining tables the one with the longest sequence of history in its indexing information is selected, and if none of the TAGE tables T1 to T4 generate a hit then the base predictor T0 is selected.

This approach is extremely useful for providing high performance because a single table indexed with a fixed length of history has to trade off the accuracy of predictions against the likelihood of lookups hitting in the table. A table indexed with a relatively short sequence of history may be more likely to generate a hit, because it is more likely that the recently seen history leading to the current state is the same as a previously seen sequence of history for which an entry is recorded in the table, but as the shorter sequence of history cannot distinguish as precisely between the different routes by which the program flow may have reached the current state (e.g., it provides a smaller amount of context information for a given instance of the instruction), it is more likely that the prediction indicated in the hit entry may be incorrect. On the other hand, a table which is indexed based on the longest sequence of history (e.g., T4) can be extremely useful for predicting harder to predict instructions which need to delve further into the past in terms of exploring the history so that that the pattern of program execution which led to that instruction can be characterised and an accurate prediction made, however, it is less likely on subsequent occasions that the longer sequence of history will exactly match the sequence of history leading up to the current state and so the hit rate is lower in a table indexed based on a longer sequence of history. By providing a range of tables with different lengths of history used for table lookups, this can balance these factors so that while the hardest predictions can be successfully predicted with the longer table, other easier to predict instructions which do not require the full prediction capability can be predicted using one of the earlier tables indexed based on shorter history so that it is more likely that a hit will be detected on a prediction lookup, thus increasing the percentage of instructions for which a successful prediction can be made and therefore improving prediction accuracy and performance.

The value prediction blocklist is particularly useful in examples employing a plurality of TAGE tables for data value prediction as illustrated in FIG. 7. A TAGE arrangement of value prediction tables may lead to a proliferation of value prediction entries associated with a single instruction, and hence individual instructions may be responsible for a significant amount of pollution in the value prediction storage.

In particular, each TAGE table stores entries associated with a PC value and a branch history. This means that within each TAGE table there may be several entries associated with the same PC value (i.e., associated with the same instruction) but having different branch histories. Certain instructions may be encountered many times in a program in different contexts, and hence may be encountered many times with different branch histories. A subroutine for example may be called from various points in a program and hence the instructions within the subroutine may be executed across a range of different branch histories, meaning that a number of entries associated with a single instruction may be created in each TAGE table. In the TAGE arrangement, this problem is not constrained to a particular table and a single instruction may lead to several value prediction entries being created within each of several TAGE tables, multiplying the problem further and resulting in a single instruction causing allocation of a significant number of value prediction entries across the value prediction storage. When the instruction responsible for creating this large number of value prediction entries is difficult to predict, then the large number of value prediction entries may be essentially useless and have potentially caused several useful value prediction entries to be evicted from the TAGE tables, leading to a decrease in coverage (and an increase in power consumption associated with evicting and allocating entries).

Providing a value prediction blocklist can allow individual problematic instructions to be identified and blocked from allocation to the TAGE tables. Hence, individual instructions which are likely to cause many value prediction entries to be allocated (e.g., instructions which are in a subroutine), and which are difficult to predict, can be identified as blocked instructions and the impact of value prediction entry allocations associated with those blocked instructions can be avoided.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

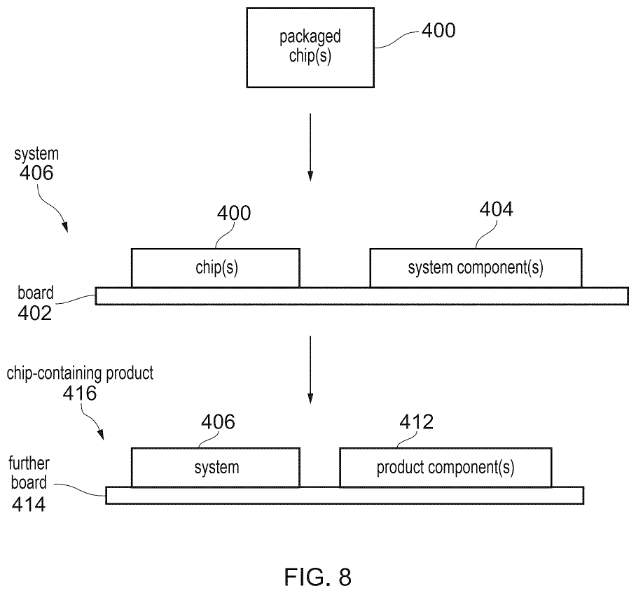

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a larger chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus, comprising
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation count indicating a number of times a value prediction entry associated with the target instruction has been allocated to the value prediction storage.
2. The apparatus according to clause 1, wherein the blocklist allocation circuitry is configured to determine whether to add the target instruction to the value prediction blocklist in dependence on whether the allocation count exceeds an allocation threshold.
3. The apparatus according to any preceding clause, wherein the blocklist allocation circuitry is configured to determine whether to add the target instruction to the value prediction blocklist in dependence on a prediction count indicating a number of times value prediction circuitry has predicted an outcome of the target instruction using the value prediction storage.
4. The apparatus according to any preceding clause, wherein each value prediction entry is configured to provide a confidence indication associated with the data value prediction; and
the blocklist allocation circuitry is configured to determine whether to add the target instruction to the value prediction blocklist in dependence on a given confidence indication provided by a value prediction entry associated with the target instruction.
5. The apparatus according to clause 4, wherein the value prediction storage is configured to permit storage of a plurality of value prediction entries associated with the target instruction, and
the given confidence indication comprises a highest confidence indication provided by any value prediction entry associated with the target instruction.
6. The apparatus according to any of clauses 4 and 5, comprising value prediction circuitry responsive to a pending instruction to perform a lookup in the value prediction storage,
wherein in response to identifying a matching value prediction entry corresponding to the pending instruction for which the confidence indication exceeds a prediction threshold, the value prediction circuitry is configured to provide the data value prediction of the matching value prediction entry as a predicted outcome of the pending instruction; and
the blocklist allocation circuitry is configured to determine whether to add the target instruction to the value prediction blocklist in dependence on whether the given confidence indication exceeds the prediction threshold.
7. The apparatus according to any preceding clause, wherein at least a subset of value prediction entries in the value prediction storage are associated with a combination of the corresponding instruction and a corresponding instruction context.
8. The apparatus according to clause 7, wherein the corresponding instruction context comprises a branch history.
9. The apparatus according to clause 8, wherein the value prediction storage is configured to store value prediction entries associated with different lengths of branch history.
10. The apparatus according to any of clauses 7 to 9, wherein the value prediction blocklist is configured to identify instructions independent from an instruction context.
11. The apparatus according to any preceding clause, wherein the value prediction blocklist is configured to identify a given blocked instruction using a tag value based on a memory addresses of the given blocked instruction.
12. The apparatus according to any preceding clause, wherein the value prediction blocklist comprises a plurality of blocklist entries, each blocklist entry identifying a blocked instruction; and
the value prediction blocklist has a replacement policy favouring eviction of older blocklist entries.
13. The apparatus according to any preceding clause, wherein the value prediction allocation circuitry is responsive to observing an outcome of the given instruction to determine whether to allocate the given value prediction entry to the value prediction storage.
14. The apparatus according to any preceding clause, wherein each value prediction entry is configured to provide a confidence indication associated with the data value prediction; and
training circuitry is configured to increment the confidence indication in response to determining that an observed data value outcome of the corresponding instruction matches the data value prediction.
15. The apparatus according to any preceding clause, wherein the value prediction storage is configured to provide value prediction entries associated with load instructions.
16. The apparatus according to any preceding clause, comprising blocklist training storage comprising a plurality of blocklist training entries, each blocklist training entry providing an allocation count for an associated instruction.
17. A system comprising:
the apparatus of any preceding clause, implemented in at least one packaged chip;
at least one system component; and
a board,
wherein the at least one packaged chip and the at least one system component are assembled on the board.
18. A chip-containing product comprising the system of clause 17, wherein the system is assembled on a further board with at least one other product component.
19. A method, comprising
storing a plurality of value prediction entries in value prediction storage, each value prediction entry providing a data value prediction associated with a corresponding instruction;
providing a value prediction blocklist identifying one or more blocked instructions;
controlling whether to allocate a given value prediction entry associated with a given instruction to the value prediction storage in dependence on whether the given instruction is identified as a blocked instruction by the value prediction blocklist; and
determining whether to add a target instruction to the value prediction blocklist in dependence on an allocation count indicating a number of times a value prediction entry associated with the target instruction has been allocated to the value prediction storage.
20. Computer-readable code for fabrication of an apparatus comprising:
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation count indicating a number of times a value prediction entry associated with the target instruction has been allocated to the value prediction storage.

In summary, an apparatus comprises value prediction storage storing value prediction entries, each value prediction entry providing a data value prediction associated with a corresponding instruction. A value prediction blocklist identifies one or more blocked instructions, and value prediction allocation circuitry is configured to control whether to allocate a given value prediction entry associated with a given instruction to the value prediction storage in dependence on whether the given instruction is identified as a blocked instruction by the value prediction blocklist. Blocklist allocation circuitry determines whether to add a target instruction to the value prediction blocklist in dependence on an allocation count indicating a number of times a value prediction entry associated with the target instruction has been allocated to the value prediction storage.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation count indicating a number of times a value prediction entry associated with the target instruction has been allocated to the value prediction storage.

2. The apparatus according to claim 1, wherein the blocklist allocation circuitry is configured to determine whether to add the target instruction to the value prediction blocklist in dependence on whether the allocation count exceeds an allocation threshold.

3. The apparatus according to claim 1, wherein the blocklist allocation circuitry is configured to determine whether to add the target instruction to the value prediction blocklist in dependence on a prediction count indicating a number of times value prediction circuitry has predicted an outcome of the target instruction using the value prediction storage.

4. The apparatus according to claim 1, wherein each value prediction entry is configured to provide a confidence indication associated with the data value prediction; and
the blocklist allocation circuitry is configured to determine whether to add the target instruction to the value prediction blocklist in dependence on a given confidence indication provided by a value prediction entry associated with the target instruction.

5. The apparatus according to claim 4, wherein the value prediction storage is configured to permit storage of a plurality of value prediction entries associated with the target instruction, and
the given confidence indication comprises a highest confidence indication provided by any value prediction entry associated with the target instruction.

6. The apparatus according to claim 4, comprising value prediction circuitry responsive to a pending instruction to perform a lookup in the value prediction storage,
wherein in response to identifying a matching value prediction entry corresponding to the pending instruction for which the confidence indication exceeds a prediction threshold, the value prediction circuitry is configured to provide the data value prediction of the matching value prediction entry as a predicted outcome of the pending instruction; and
the blocklist allocation circuitry is configured to determine whether to add the target instruction to the value prediction blocklist in dependence on whether the given confidence indication exceeds the prediction threshold.

7. The apparatus according to claim 1, wherein at least a subset of value prediction entries in the value prediction storage are associated with a combination of the corresponding instruction and a corresponding instruction context.

8. The apparatus according to claim 7, wherein the corresponding instruction context comprises a branch history.

9. The apparatus according to claim 8, wherein the value prediction storage is configured to store value prediction entries associated with different lengths of branch history.

10. The apparatus according to claim 7, wherein the value prediction blocklist is configured to identify instructions independent from an instruction context.

11. The apparatus according to claim 1, wherein the value prediction blocklist is configured to identify a given blocked instruction using a tag value based on a memory addresses of the given blocked instruction.

12. The apparatus according to claim 1, wherein the value prediction blocklist comprises a plurality of blocklist entries, each blocklist entry identifying a blocked instruction; and
the value prediction blocklist has a replacement policy favouring eviction of older blocklist entries.

13. The apparatus according to claim 1, wherein the value prediction allocation circuitry is responsive to observing an outcome of the given instruction to determine whether to allocate the given value prediction entry to the value prediction storage.

14. The apparatus according to claim 1, wherein each value prediction entry is configured to provide a confidence indication associated with the data value prediction; and
training circuitry is configured to increment the confidence indication in response to determining that an observed data value outcome of the corresponding instruction matches the data value prediction.

15. The apparatus according to claim 1, wherein the value prediction storage is configured to provide value prediction entries associated with load instructions.

16. The apparatus according to claim 1, comprising blocklist training storage comprising a plurality of blocklist training entries, each blocklist training entry providing an allocation count for an associated instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising
storing a plurality of value prediction entries in value prediction storage, each value prediction entry providing a data value prediction associated with a corresponding instruction;
providing a value prediction blocklist identifying one or more blocked instructions;
controlling whether to allocate a given value prediction entry associated with a given instruction to the value prediction storage in dependence on whether the given instruction is identified as a blocked instruction by the value prediction blocklist; and
determining whether to add a target instruction to the value prediction blocklist in dependence on an allocation count indicating a number of times a value prediction entry associated with the target instruction has been allocated to the value prediction storage.

20. A non-transitory computer-readable medium storing computer-readable code for fabrication of an apparatus comprising:
value prediction storage comprising a plurality of value prediction entries, each value prediction entry providing a data value prediction associated with a corresponding instruction;
a value prediction blocklist identifying one or more blocked instructions;
value prediction allocation circuitry configured to control whether to allocate a given value prediction entry associated with a given instruction to the value prediction storage in dependence on whether the given instruction is identified as a blocked instruction by the value prediction blocklist; and
blocklist allocation circuitry configured to determine whether to add a target instruction to the value prediction blocklist in dependence on an allocation count indicating a number of times a value prediction entry associated with the target instruction has been allocated to the value prediction storage.
